(19) United States
(12) Patent Application Publication
(10) Pub. No.: US 2009/0220657 A1
(43) Pub. Date: Sep. 3, 2009

(54) Automatic Pizza Shaping Conveyor Device and Method

(76) Inventor: Jen-ho Yen, Keelong City (TW)

Correspondence Address: THE NATH LAW GROUP, 112 South West Street, Alexandria, VA, 22314, US

(21) Appl. No.: 12/226,768

(22) PCT Filed: Apr. 27, 2007
(86) PCT No.: PCT/CA2007/000725

§ 371 Date: May 13, 2009

(30) Foreign Application Priority Data
Apr. 28, 2006 (TW) 095207388

(51) Int. Cl. A23L 1/00; A21D 6/00; A21C 11/10; A21B 1/48; A21C 13/02; A21C 11/06

(52) U.S. Cl. 426/296; 426/503; 99/443 C; 425/364 R

(57) ABSTRACT

An automatic pizza shaping conveyor device and process of making a pizza are disclosed. The device has a dough machine, a shaping component, a heater and a conveyor. The dough machine receives handmade dough or machine-kneaded dough and processes the dough into pizza ready dough. The processed dough is sent by the conveyor to the shaping component, which processes the dough into 45 wedges and receives toppings which are added to the wedges. The heater then receives the wedges to which the toppings have been added, heats and cooks the wedges to produce the completed pizza product. The process takes uncooked or raw dough and produces an elongate sheet of pizza dough, cuts alternately oriented 45 degree shaped pie-shaped segments from the sheet of dough, but keeps the segments touching each other, applies pizza sauce, cheese and other ingredients to the cut segments to produce coated segments, and then conveys the coated segments through an oven.

### FIELD OF THE INVENTION

This invention pertains to an improvement to an automated pizza shaping conveyor device, and particularly pertains to an automated shaping conveyor device that automatically processes and bakes a pizza.

### BACKGROUND OF THE INVENTION

Conventional pizzas are handmade from mixing flour, salt, yeast and the like in proper proportions. The dough is made from mixing and blending flour, and then is continuously kneaded and shaped into a traditional round shaped pizza having the desired size and rotundity. Pizza sauce is poured onto the shaped dough and selected toppings of cheese and seasonings are added. The pizza is then placed into a cooking oven where the pizza dough is cooked until it turns a golden color. The cooked pizza is then removed and sliced into segments of even size with a cutter.

The making of the aforesaid handmade pizza is not only time-consuming, which invariably adds many human hands, but is also requires training of a beginner before he or she is able to work alone. Also, such personnel training increases the cost of making the pizza and is not compatible for with mass production. There is also the realization that if the pizza is made by humans, the quality of the product is subjected to the result of humans being prone to be affected by emotions. Consequently, not only is quality control made difficult, but the reduction of production costs is also difficult because human factors account for a majority of the production process.

### SUMMARY OF THE INVENTION

The present invention seeks to overcome, or at least to reduce, the aforesaid difficulties of the almost entirely manual processing in the making of a cooked pizza.

According to one embodiment of the present invention, an improvement of the manual process of making a pizza by utilizing an automatic pizza shaping conveyor device is disclosed. The device is primarily comprised of a dough machine, a form shaping component or shaper, a conveyor and a heater or oven.

The dough machine receives prepared dough and it processes the dough into pizza dough. The conveyor receives the processed dough from the dough machine and transfers it to the shaper, which cuts the dough into segments, pours pizza sauce onto the segments, and sprinkles selected seasonings onto the sauce covered segments. The conveyor then sends the segments to the heater for baking.

More particularly, the present invention provides an automatic pizza shaping conveyor device that includes a plurality of stations, and comprises:

a dough machine which receives raw dough and processes the raw dough into an elongate sheet;

a conveyor associated with said dough machine which receives the sheet of pizza dough and conveys it to other stations along the path of said conveyor;

a shaper which cuts the sheet into a plurality of segments; and

a sauce application station at which pizza sauce is applied to an upper surface of said segments, and at which cheese and other seasonings are applied all resulting in coated segments.

In light of which, the inventor has devised an automated pizza shaping conveyor device, whereby kneaded dough is placed into the dough machine for producing the pizza dough, which is then forwarded via the conveyor to the shaper, and then sauce is added and the pizza is heated by the heater to a golden hue. The shaper cuts the shaped dough into 45-degree pizza segments or slices. In other words, the shaped dough is divided into various segments without any further cutting.

The invention improved automated pizza shaping conveyor device offers a serial operation that not only serves to reduce manpower, thereby saving time, but it also affords the possibility of making pizza production into a mass production operation. The present invention also saves cost of making pizzas in various sizes, and effortlessly results in the making of a pizza having a consistently good quality.

The present invention also concerns an automatic process of making a cooked pizza comprising the steps of:

processing dough into an elongate sheet of dough at a dough processing station;

conveying said sheet of dough from said from said dough processing station;

cutting said conveyed sheet of dough into a plurality of substantially identical 45 degree segments;

conveying said cut segments to a healer; and

cooking said segments in said heater.

### BRIEF DESCRIPTION OF THE DRAWINGS

An example of the present invention is now described with reference to the accompanying drawings, in which:

FIG. 1 is a somewhat schematic, side elevational view that shows an assembled configuration of a embodiment of the present invention; and

FIG. 2 is a top plan view that shows a round pizza that is comprised of eight pieces of any desirable size in which each piece encompasses a 45 degree sector.

### DETAILED DESCRIPTION OF THE PREFERRED EMBODIMENT

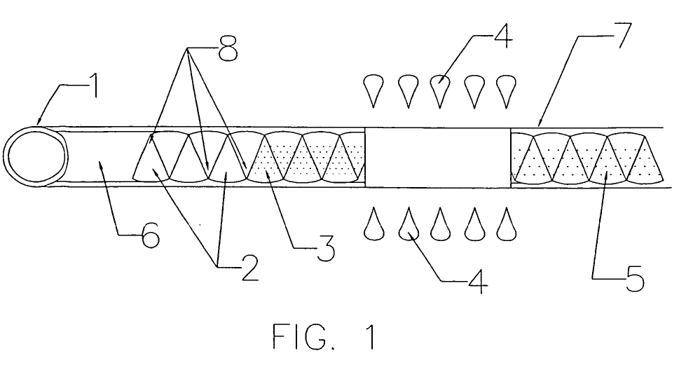

An automated pizza shaping conveyor device is depicted in FIG. 1. The device is primarily comprised of a dough machine 1, a shaper 8, a heater 4 and a conveyor 7.

Dough machine 1 processes the dough into pizza dough 6 of proper thickness and diameter in a conventional manner and deposits it onto conveyor 7, which is operationally connected to it. Conveyor 7 receives the processed dough as a continuous or endless sheet 6 that is somewhat rectangular in a transverse cross-section having a predetermined, but adjustable thickness. Conveyor 7 can be a conventional belt-type continuous conveyor. Conveyor 7 transmits sheet 6 to the next workstation, which is in the present embodiment is shaper 8.

Conveyor 7 either includes a shaping component or is connected with a shaper, both of which are referred to herein as shaper 8. Thus, shaper 8 is located on conveyor 7 or at a station along conveyor 7. Shaper 8 is comprised of several identical pie-shaped molds that are arranged as interleaved components, with alternating molds pointing in the same direction, but in the opposite direction of the mold adjacent to it, that is on either side of it. The molds can be connected together to form an elongated shaper 8. Supporting mechanisms and actuating mechanisms, not shown, carry the molds and cause them to move in a generally orthogonal direction to the upper surface of sheet 6 of pizza dough, contact dough sheet 8 on its upper surface and in a continued movement, cause the shaper molds to cut into the pizza dough 6 and divide the dough 6 into several identical pie-shaped segments 2.

In addition, next to shaper 8, along the direction of the movement of conveyor 7, is heater 4. Heater 4 is somewhat conventional and includes a conventional bake tray. Associated with heater 4 are conventional temperature controls and time controls that include dial or button.

By placing handmade dough into the dough machine 1, the dough machine 1 processes the dough into an elongate sheet of pizza dough 6, and the conveyor sends the dough to the shaper 8, where the shaper=s several identical molds cut the uncooked pizza dough 6 into a plurality of identical, back-to-back 45-degree segments 2. The cut segments 2 are conveyed by conveyor 7 to a station where a sauce is poured onto the upper surface of segments 2, or otherwise applied thereto, and other ingredients, such as conventional toppings (e.g. meat, ham, pepperoni, onions, green peppers, anchovies and the like) are applied, to produce covered, uncooked segments 3. While in one embodiment the cut segments are substantially identical such that any eight segments can be combined together to form a round pizza, in another embodiment, the molds can have different shapes to for producing different shapes of pizza, such as a square pizza. Also, in other embodiment, the molds are either replaceable, or movable out of the cutting way, and other different sized molds can be used to cut a 45 degree segment having a selected size. Thus, the overall size of the pizza can be varied from, for example, a 9 inch diameter pizza to a 16 inch diameter pizza.

After the segments are covered with sauce and other ingredients, the segments are conveyed by conveyer 7 to the bake tray at heater 4. Adjustments to the heater is done on a conventional control panel where adjustment is made through the heater panel=s setting for baking temperature and time until the pizza 5 is baked to a golden hue.

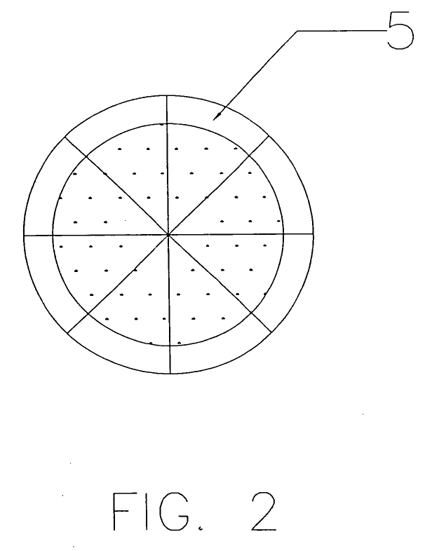

The present invention allows any eight 45-degree pizza segments to be assembled to form a round pizza as shown in FIG. 2. Thus, although produced in a continuous stream of identical pie-shaped pieces 2, a conventional round pizza can be assembled and sent to the client. Thus, the conventional round shape of a pizza is not compromised.

The invention=s automated pizza shaping conveyor device offers a serial operation that reduces human hand not only serves to save time making it suitable for mass production, but it also saves cost for how it is able to produce pizzas of varied sizes and in stable quality.

While the invention has been particularly shown and described with reference to a particular embodiment, it will be appreciated that various of the above-disclosed and other features and functions, or alternatives thereof, may be desirably combined into many other different systems or applications. Also, the various presently unforeseen and unanticipated alternatives, modifications, variations, or improvements therein may be subsequently made by those skilled in the art which are also intended to be encompassed by the following claims. Although the invention has been described with reference to specific preferred embodiments, it is not intended to be limited thereto, rather those having ordinary skill in the art will recognize that variations and modifications may be made therein which are within the spirit of the invention and within the scope of the claims.

I claim:

1. An automatic pizza shaping conveyor device that includes a plurality of stations, and comprises:
a dough machine which receives raw dough and processes the raw dough into an elongate sheet;
a conveyor associated with said dough machine which receives the sheet of pizza dough and conveys it to other stations along the path of said conveyor;
a shaper which cuts the sheet into a plurality of segments; and
a sauce application station at which pizza sauce is applied to an upper surface of said segments, and at which cheese and other seasonings are applied all resulting in coated segments.

2. The automatic pizza shaping conveyor device as claimed in claim 1, wherein said shaper is located at a station along said conveyor and includes a plurality of molds

3. The automatic pizza shaping conveyor device as claimed in claim 2 wherein said molds of said shaper are substantially identical.

4. The automatic pizza shaping conveyor device as claimed in claim 1 wherein said shaper includes a plurality of molds.

5. The automatic pizza shaping conveyor device as claimed in claim 4 wherein said molds of said shaper are substantially identical.

6. The automatic pizza shaping conveyor device as claimed in claim 5, wherein the shaper's molds separate the dough into a number of substantially identical 45-degree segments at a time such that any eight of said segments can be later assembled into a 360 degree, round pizza at a later time.

7. The automatic pizza shaping conveyor device as claimed in claim 4, wherein the several molds attached to the shaper are not limited to 45-degree segment molds but can also be designed into varied mold shapes for producing pizza of varied shapes.

8. The automatic pizza shaping conveyor device as claimed in claim 1, wherein said shaper includes different sizes of molds, each mold can cut a 45 degrees segment of various sizes of segments for producing correspondingly different sizes of pizza.

9. The automatic pizza shaping conveyor device as claimed in claim 1, and further comprising a heater located at a station along said conveyor to which the coated segments are baking.

10. The automatic pizza shaping conveyor device as claimed in claim 1, wherein following the shaper along the path of the conveyor is a heater, which heats from the top and bottom, and a bake stray is contained within the heater, and beyond are the temperature control and time dial or button.

11. The automatic pizza shaping conveyor device as claimed in claim 1, wherein said sheet is an endless sheet.

12. An automatic pizza shaping conveyor device that includes a plurality of stations, and comprises:
a dough machine which receives raw dough and processes the raw dough into an elongate sheet;
a conveyor associated with said dough machine which receives the sheet of pizza dough and conveys it to other stations along the path of said conveyor;
a shaper at a station along said conveyor which cuts the sheet into a plurality of segments; and
a heater at a station along said conveyor which cooks the segments.

13. The automatic pizza shaping conveyor device as claimed in claim 12, wherein said conveyor conveys said cut segments though said healer for a continuous flow baking.

14. An automatic process of making a cooked pizza comprising the steps of:
processing dough into an elongate sheet of dough at a dough processing station;
conveying said sheet of dough from said from said dough processing station;
cutting said conveyed sheet of dough into a plurality of substantially identical 45 degree segments;
conveying said cut segments to a heater; and
cooking said segments in said heater.

15. The automatic process of making a cooked pizza as claimed in claim 14, and further comprising conveying with a conveyor said sheet of dough from said dough processing station directly to a shaping station where said sheet of dough is cut into a plurality of segments.

16. The automatic process of making a cooked pizza as claimed in claim 15, wherein said cutting step cuts said elongate sheet of dough into a plurality of adjacent, identically pie-shaped 45 degree segments, each segment having a pointed end and an arcuate end, and said segments being cut such that a pointed end of one segment is adjacent an arcuate end of the segments on either side thereof.

17. An automatic process of making a cooked pizza as claimed in claim 16, and further including the step of using the same conveyer from said dough processing station to and through said heater.

18. An automatic process of making a cooked pizza as claimed in claim 14, and further comprising an ingredient application station located along said conveyor downstream from said cutting station, and wherein sauce and other ingredients are applied to an upper surface of said cut segments to produce a coated segment.

19. An automatic process of making a cooked pizza as claimed in claim 18, wherein said coated segments are directly conveyed from said ingredient application station to said heater where they are cooked.

20. An automatic process of making a cooked pizza as claimed in claim 18:
wherein said cutting step cuts said elongate sheet of dough into a plurality of adjacent, identically pie-shaped 45 degree segments, each segment having a pointed end and an arcuate end, and said segments being cut such that a pointed end of one segment is adjacent an arcuate end of the segments on either side thereof;
and further comprising the step of selecting any eight pieces of cooked segments and assembling them into a circular pizza.
